(19) United States
(12) Patent Application Publication
(10) Pub. No.: US 2022/0355225 A1
(43) Pub. Date: Nov. 10, 2022

(54) Externally Fed Screen for Filtration

(71) Applicant: Lyco Manufacturing Inc., Columbus, WI (US)

(72) Inventors: Daniel D. Maupin, Corvallis, OR (US); Jeffrey S. Zittel, Columbus, WI (US); David R. Zittel, Columbus, WI (US)

(73) Assignee: Lyco Manufacturing Inc., Columbus, WI (US)

(21) Appl. No.: 17/316,272

(22) Filed: May 10, 2021

(51) Int. Cl. B01D 33/073; B01D 33/46; B01D 33/067; B01D 33/80

(52) U.S. Cl. CPC B01D 33/073; B01D 33/466; B01D 33/463; B01D 33/067; B01D 33/807; B01D 2201/087

(57) ABSTRACT

A food processing water filtration apparatus includes a rotatable drum, a source of liquid, a blade to remove solids from the drum, a drain, and a rotational drive. The system has one or more of a plurality of flights affixed to the drum, a source of mixing gas connected to the source of liquid, a source of cleaning gas connected to nozzles disposed inside the drum, and a trunnion support for an end of the drum. The drum is cylindrical and at least partially comprised of a screen. The source of liquid directs liquid towards the screen and into the drum. The drain collects at least a second portion of the liquid that passes through the screen and out of the drum. The outlet is at one or both ends of the drum. The rotational drive is connected to an end(s) of the drum, and rotates the drum.

### FIELD OF THE INVENTION

The present disclosure relates generally to the art of liquid filtration. More specifically, it relates to using an externally fed screen to filter liquid used in food processing and carrying suspended solids.

### BACKGROUND OF THE INVENTION

Commercial food processing typically involves using water to heat or cool food products. Often the process results in the water or fluid carrying suspended solids. It is desirable to filter those solids so that the water can either be reused or be more easily treated by standard waste water systems.

One prior art system for filtering food processing water is to apply the water to a cylindrical-shaped screen (a drum). The fluid to be filtered can be introduced to the inside of the drum. The drum is oriented horizontally, and the drum rotates. The screen filters the fluid. The cleaned fluid passes out of the lower surface, and the suspended solids/food product is trapped on the screen inside the drum. The solids must be periodically removed from the interior of the drum. This is an internally fed design.

Another known design is an externally fed screen drum, where the fluid is introduced to the top or sides of the cylindrical surface of rotating and horizontal oriented drum. The fluid pass through the screen to the interior of the drum. Solids are caught on the outside of the screen drum. Scrapers are used to scrape the solids off the outside of the drum. The partially filtered water (now inside the drum) passes through the lower part of the cylindrical screen surface, and is filtered again. Screens are typically made of wedge wire, which by their shape tend to allow catch suspended solids, but some solids are carried into the drum, and caught by the screen as the water leaves the drum. This causes buildup inside and the solids filtered must be removed from inside the drum.

Prior art externally fed screens lack strength and would often break in use. Some prior art designs used a “doughnut” support in the center or interior of the screen. While this provides beam strength it does not provide torsional strength. Torsional strength is important to help the scraping blades work. The torsional stress on screens from scraping and from being driven at one end can cause failure of the screen.

Other problems with prior art externally fed screens are solids passing through the screens, cleaning screens with cleaning liquid resulting in more waste water, difficulty cleaning the inside of screens, and difficulty in adjusting drum position (for operating and cleaning).

Prior art externally fed screens for filtering received the fluid to be filtered from an inlet pipe, and that resulted in the screen filtering primarily close to the inlet pipe (the center of the screen in the most systems). Prior art systems attempt to address this by keeping velocity of the fluid to be filtered low (to allow the suspended solids to spread out across the screen). However, the low velocity of the fluid allows solids to settle out in the infeed area, reducing the effectiveness of the screen. Often the solids must be periodically removed by manual means (shovel or scoop or bucket).

Prior art systems provide internal CIP (clean in place) headers and nozzles along the drum axis to spray liquid such as water toward the screen to clean the screen. This results in adding water to the effluent.

Prior art systems were difficult to clean, in particularly the inside of the drum was difficult to clean because they did not provide easy access to some areas of the screen for cleaning. For some applications the water is waste water and sanitation features are not as important, but other applications the drums do require cleaning.

Accordingly, an externally fed screen for filtering water used in food processing that provides structural support, and/or is easy to clean, and/or provides for better filtering, and/or is easier to positionally adjust, is desired.

### SUMMARY OF THE PRESENT INVENTION

According to a first aspect of the disclosure a food processing water filtration apparatus includes a rotatable drum, a source of liquid with suspended solids to be filtered, a blade disposed to remove solids from the exterior of the drum, a drain, a solids outlet, a rotational drive and a plurality of flights affixed to the interior of the drum. The rotatable drum has first and second ends, and has a cylindrical surface at least partially comprised of a screen. The source of liquid with suspended solids is disposed outside the drum and directs at least a portion of the liquid towards the screen and into the drum. The drain collects at least a second portion of the liquid that passes through the screen and out of the drum. The solids outlet is located at one or both ends of the drum. The rotational drive is connected to one of the ends of the drum, whereby the rotational drive causes the drum to rotate.

According to a second aspect of the disclosure a food processing water filtration apparatus includes a rotatable drum, a source of liquid with suspended solids to be filtered, a blade disposed to remove solids from the exterior of the drum, a drain, a solids outlet, a rotational drive and a source of mixing gas connected to the source of liquid with suspended solids. The rotatable drum has first and second ends, and has a cylindrical surface at least partially comprised of a screen. The source of liquid with suspended solids is disposed outside the drum and directs at least a portion of the liquid towards the screen and into the drum. The drain collects at least a second portion of the liquid that passes through the screen and out of the drum. The solids outlet is located at one or both ends of the drum. The rotational drive is connected to one of the ends of the drum, whereby the rotational drive causes the drum to rotate.

According to a third aspect of the disclosure a food processing water filtration apparatus includes a rotatable drum, a source of liquid with suspended solids to be filtered, a blade disposed to remove solids from the exterior of the drum, a drain, a solids outlet, a rotational drive, a source of cleaning gas, and a plurality of nozzles connected to the source of cleaning gas and disposed inside the drum to direct the cleaning fluid to the screen to clean the screen. The rotatable drum has first and second ends, and has a cylindrical surface at least partially comprised of a screen. The source of liquid with suspended solids is disposed outside the drum and directs at least a portion of the liquid towards the screen and into the drum. The drain collects at least a second portion of the liquid that passes through the screen and out of the drum. The solids outlet is located at one or both ends of the drum. The rotational drive is connected to one of the ends of the drum, whereby the rotational drive causes the drum to rotate.

According to a fourth aspect of the disclosure a food processing water filtration apparatus includes a rotatable drum, a source of liquid with suspended solids to be filtered, a blade disposed to remove solids from the exterior of the drum, a drain, a solids outlet, a rotational drive and a trunnion support supporting an end of the drum. The rotatable drum has first and second ends, and has a cylindrical surface at least partially comprised of a screen. The source of liquid with suspended solids is disposed outside the drum and directs at least a portion of the liquid towards the screen and into the drum. The drain collects at least a second portion of the liquid that passes through the screen and out of the drum. The solids outlet is located at one or both ends of the drum. The rotational drive is connected to one of the ends of the drum, whereby the rotational drive causes the drum to rotate.

A source of mixing gas is connected to the source of liquid with suspended solids in one alternative.

A source of cleaning fluid is provided and a plurality of nozzles are connected to the source of cleaning fluid and disposed inside the drum to direct the cleaning fluid to the screen to clean the screen in another alternative.

The source of cleaning fluid includes a source of cleaning gas that is connected to the plurality of nozzles in one embodiment.

A first trunnion support is disposed at one end of the drum to support the first end of the drum, in various embodiments.

The flights are rigid and thereby provide rigidity to the drum, and/or as the drum rotates the flights move filtered material toward the first end in one alternative.

A variable speed module is connected to the source of liquid, and controls the rotational drive in response to a sensed level of fluid in the source of liquid with suspended solids to be filtered in another alternative.

A plurality of flights are affixed to the interior of the drum in one embodiment.

A second trunnion support is disposed at a second end of the drum to support the second end of the drum in one alternative.

Other principal features and advantages of will become apparent to those skilled in the art upon review of the following drawings, the detailed description and the appended claims.

### BRIEF DESCRIPTION OF THE DRAWINGS

FIG. 1 is a perspective view of a first end of a water filtration system in accordance with the preferred embodiment;

FIG. 2 is a perspective view of a second end of the water filtration system of FIG. 1, in accordance with the preferred embodiment;

FIG. 3 is a cut-away end view of the water filtration system of FIG. 1, in accordance with the preferred embodiment;

FIG. 4 is a cut-away perspective view of the water filtration system of FIG. 1, in accordance with the preferred embodiment;

FIG. 5 is a cut-away perspective view of the water filtration system of FIG. 1, in accordance with the preferred embodiment; and

FIG. 6 is a variable speed module for the water filtration system of FIG. 1, in accordance with the preferred embodiment.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present disclosure will be illustrated with reference to a particular food processing water filtration system implemented with a particular drum/screen having a number of features, it should be understood at the outset that the system can be implemented using other components, and using fewer than all of the features described herein. Also, the invention can be used in filtering applications other than food processing. Food processing water filtration, as used herein, refers to an apparatus, method, system used to filter water that was used in food processing, wherein the water includes solids suspended therein or solids carried by the water.

Generally, the preferred embodiment includes an externally fed screen drum similar to prior art screens, and is implemented using wedge wire shaped into a drum. The drum is oriented horizontally (i.e, the axis of the drum is generally horizontal), and is rotated by at least one drive at one end (drives can be at both ends). The fluid to be filtered is introduced to the upper or side of the cylindrical surface, and passes through the screen to the inside of the drum. Most of the solids are trapped on the outside of the drum. Consistent with prior art designs, scrapers are provided on the exterior of the drum to remove the solids filtered. Fluid on the inside of the drum passes through the bottom of the cylindrical surface, and is collected by a drain. It can then be filtered in a further stage, disposed of, or reused depending on the system and application. Solids are also caught on the inside of the screen. Clean in place nozzles are provided to clean the screen without dismantling the drum.

The preferred embodiment differs from prior art externally fed screens by including a series of flights on the inside of the drum, and/or having air injected into the liquid to be filtered, and/or providing air to the clean in place nozzles, and/or providing adjustable trunnions at one or both ends to allow for adjusting the drum position for cleaning or for operating. Alternative embodiments provide for having any number of these features.

The flights on the inside of the drum of the preferred embodiment are affixed to the screen and provide torsional and beam strength to the screens. This reduces the likelihood of the screen breaking or failing. Also, the flights can urge captured solids to an outlet end of the drum. The flights can be affixed to the screen by welding, clamping, bolting, riveting, etc,

Air is injected into the liquid to be filtered in the preferred embodiment to agitate the liquid, make it more likely for solids to filtered, and make it easier to remove solids with the scraper.

Air (or air and fluid) is provided to the clean in place nozzles in the preferred embodiment to aid in the cleaning of the screens. The air injection provides better cleaning for the clean in place feature than fluid alone, and reduces the amount of added waste water. Clean in place can be performed while the filter is filtering, or when no water is being provided to filter.

The preferred embodiment includes adjustable trunnions at one or both ends so that the drum can be more easily moved to be cleaned or properly positioned for filtering.

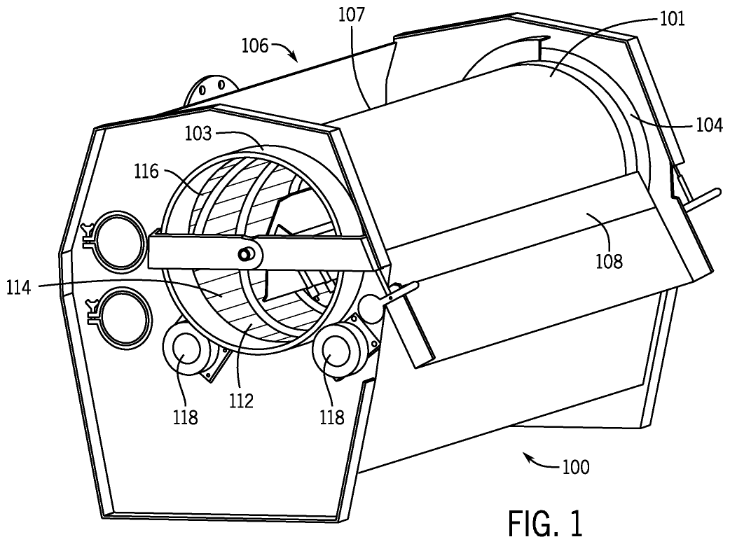

Turning now to FIG. 1, a food processing water filtration apparatus 100 is shown and includes a rotatable drum 101 having a first end 103 and a second end 104. Drum 101 is preferably comprised of wedge wire formed into a cylindrical surface as shown in FIG. 1. The entire cylindrical surface need not be screen, and as shown the ends are solid. Alternatives provide for solid portions other than at the ends. Screen drum 101 filters the water. Screen drum 101 is preferably comprised of stainless steel wedge wire having dimensions roughly triangular about 0.093 inches per side, or between 0.093 and 0.060 inches per side, or with openings that vary in size. Drum, as used herein, refers to a generally cylindrical shaped structure that can include openings at the ends and about the periphery, and can include formations used to attach supports, sources of motion, sources or fluid, etc. that vary from the generally cylindrical shape.

An area, reservoir, or weir 106 is formed by plastic (or other materials in alterative embodiments) bolted in place to seal water in the weir. Weir or reservoir 106 receives fluid with suspended solids for filtering. Reservoir or weir 106 is sealed to drum 101 with rubber at the bottom of area 106, to hold the fluid therein. Reservoir or weir 106 is also called an inlet distribution box. Reservoir/area 106 is considered a source of liquid with suspended solids, along with the plumbing that directs the liquid to reservoir/area 106. The position and shape of reservoir/area 106 against drum 101 directs the liquid in reservoir/area/weir 106 towards the screen and into the drum near a drum top or side portion 107. Clean out ports for weir 106 are also provided in system 100. The preferred embodiment includes a 24 inch diameter wire drum that is 72 inches long, and processes 300 to 400 gallons/min of slaughterhouse waste water. When water is mostly clear the preferred embodiment will process 1200 gpm.

A blade or scraper 108 is disposed to shear or scrape solids off screen drum 101. Scraper blade 108 is preferably a dissimilar material like brass, because stainless on stainless wears fast.

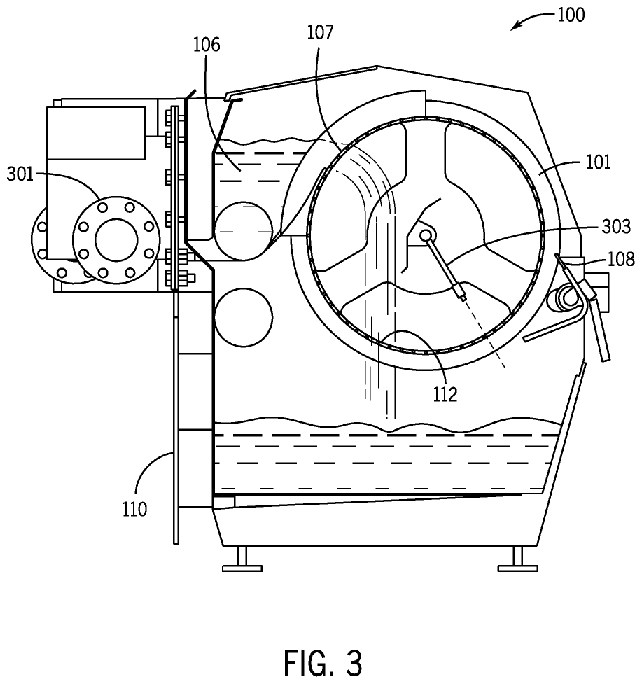

Fluid inside the drum passes through a drum bottom portion 112 and is collected by a drain 110 (located below the drum and shown in FIGS. 3-5). Drain 110 collects at least a portion of the liquid that passes through the screen and out of the drum. Drain 110 can be plumbing, pipes, openings, or any other structure or structures that removes water from beneath or the side of the drum. Additional solids are collected on the inside of drum 101. A solids outlet 114 is end 103 of drum 101 (FIG. 1). It could be located at end 104, 103, or both ends 103 and 104. Solids outlet, as used herein, refers to a location at which solids can be collected or removed from a food processing water filtration system.

A plurality of flights 116 are affixed to the interior of drum 101, preferably by welding, clamping, bolting, or riveting. As drum 101 rotates, flights 116 move filtered material toward end 103. Also, flights 116 provide rigidity to the drum and torsional and beam strength to drum 101. In the preferred embodiment flights 116 are relatively small (almost slinky like) and are welded to screen 101. Flights 116 provide strength for drum 116, which is particularly helpful where scraper blade 108 presses against drum screen 101. Some applications, such as meat processing, result in more solids being caught inside the screen, and flights 116 are useful in such applications at moving filtered material toward an end of the drum. Flights moving filtered material toward an end of a drum, as used herein, refers to the helical shape of flights advancing material as the flights rotate. Providing rigidity to the drum, as used herein, refers to structures that help support and maintain the generally cylindrical shape of a drum, particularly where the surface of the drum is comprised of a screen that lacks the rigidity of a solid structure.

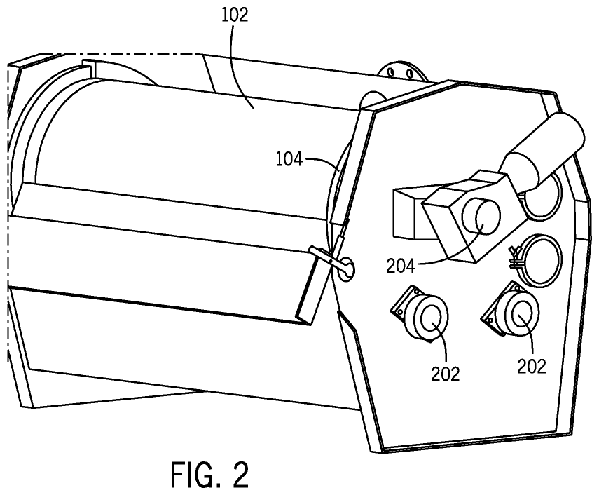

A pair of trunnions 118 are provided to support end 103 of drum 101. Trunnions 118 can be adjusted to adjust the position of drum 101. Trunnions can also be provided to support end 104 of drum 101. Turning now to FIG. 2, a second set of trunnions 202 (which extend through the end plate) support end 104 of drum 101. Alternatives provide for using trunnions on only one end of drum 101 (either end 103 or end 104). Trunnions 118 and 202 (if provided) allow screen drum 101 to be moved, allowing better access for cleaning hard to reach portions of drum 101. Trunnions 118 and 202 (if provided) allow easier access to the inside of the drum for cleaning. Trunnion, as used herein, refers to a structure such as a ring, wheels, pin, shaft or pivot on which the position of a trunnion ring or shaft and drum can be adjusted relative to the tank, and includes the cradle or support structure for the pin or pivot. By adjusting on end of the drum, the drum can be tilted relative to the tank.

A rotational drive 204 is connected end 104 of drum 101. When rotational drive 204 rotates, it causes drum 101 to rotate. Alternatives provide for drives at both ends, or drives at the trunnion end, or drives at the outlet end. Rotational drive 204 is a motor in the preferred embodiment. Rotational drive, as used herein, refers to a device that provides rotational movement to a drum, such as a motor, belt, wheel, gear, etc.

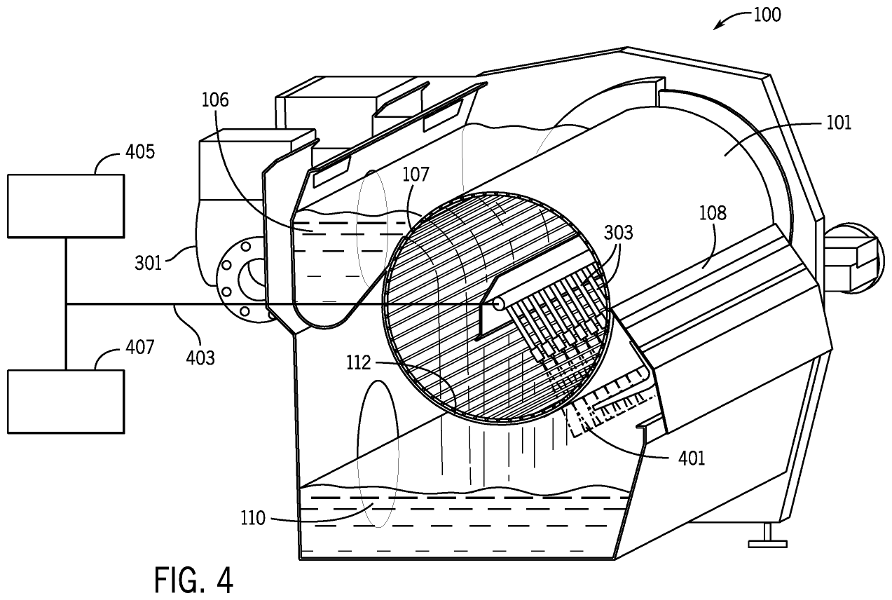

Turning now to FIGS. 3 and 4 portions of system 100 is shown. Reservoir/area 106 receives fluid from a source of fluid 301 (in this embodiment plumbing). Fluid enters drum 101 in portion 107 and exits drum 101 at portion 112, to drain 110. A plurality of nozzles 303 are provided for cleaning in place. A pipe 403 provides cleaning fluid (cleaning gas or air) to clean in place nozzles 303 along the axis of drum or screen 101, and thus is a source of cleaning fluid (fluid refers to gas and/or liquids). In various embodiments pipe 403 provides cleaning air/gas or cleaning liquid and thus is a source of cleaning gas/air and/or cleaning liquid. Nozzles 303 which spray a gas (or a gas/liquid mixture) 401 to clean drum 101. Cleaning gas, as used herein, refers to gas sprayed or injected onto a surface to clean it, such as gas used to clean-in-place filtering drums. Cleaning fluid, as used herein, refers to fluid (gas or liquid) sprayed or injected onto a surface to clean it, such as fluid used to clean-in-place filtering drums. Cleaning liquid, as used herein, refers to liquid sprayed or injected onto a surface to clean it, such as gas used to clean-in-place filtering drums. Source of gas, liquid or fluid, as used herein, refers to a structure that provides the gas, liquid or fluid, and includes compressors, pumps, pipes, tanks, blowers etc.

FIG. 4 includes a pipe 403 connected to an air/gas source 405 and a cleaning fluid source 407 (omitted from FIG. 2). During a cleaning operation cleaning fluid from source 407 and air from source 405 are injected by nozzles 303 and spray mixture 401 onto the interior of wire drum 101. Drum 101 is rotated, thus the entire interior surface is cleaned. Using a cleaning gas (or cleaning gas and liquid mix) results in less added waste water. Alternatives provide for cleaning with liquid only, air only, and of different temperatures, including steam and hot liquid. One alternative provides for using only steam. The preferred embodiment uses air only for cleaning in place, and air source 405 is a source of compressed air. Using compressed air means water is not added to the effluent. Alternatives provide for using air and water, where less water is used than traditional systems.

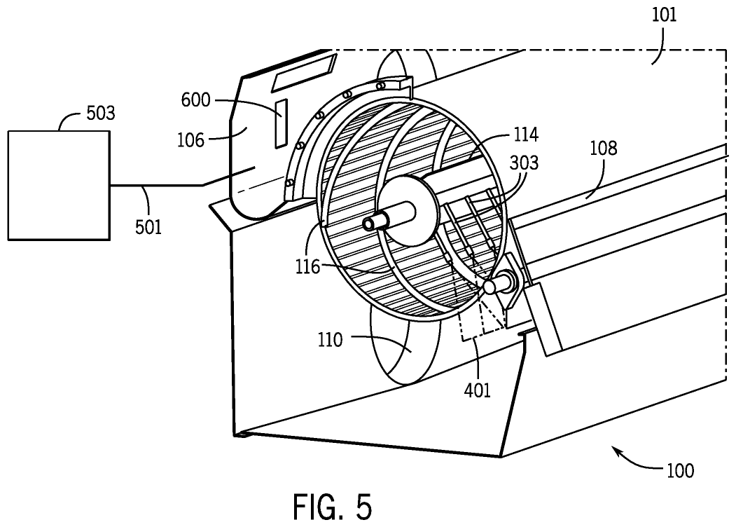

FIG. 5 shows a source of air or mixing gas 503 provided via hose or pipe 501 to reservoir or weir 106, for injecting air or other gas into the fluid to be filtered. Mixing gas, as used herein, refers to a gas to be injected into water or fluid being filtered. Air is injected in the preferred embodiment to help evenly distribute solids to the screen. The air injection helps keep solids in suspension while keeping overall velocity of the water low. Thus, the solids are suspended, and spread over a larger portion of the screen. Air source 503 can be compressed air, a high pressure blowers, or some other source.

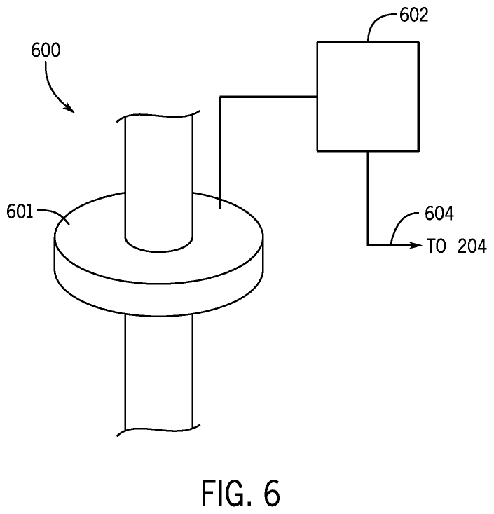

One alternative includes a variable speed module 600 (FIG. 6) having a level sender/sensor 601 (which is located in weir 106), a controller 602, and a speed control output 604. Variable speed module, as used herein, refers to a sensor and controller that cooperate to provide a variable speed rotation to drum 101. Controller 602 provides speed control output 604 responsive to the water level sensed by level sender/sensor 601. The responsiveness can be stepwise, proportional, or use any suitable control loop (such as PID, PI, etc.) The water level (in weir 106) is sensed using level sender/sensor 601, and a feedback signal is provided to controller 602. Control 602 provides a speed control output 604 to motor 204. When a higher water level is sensed the drum 101 rotates faster (presenting greater cleaned screen surface). When a lower water level is sensed drum 101 rotates more slowly, to keep material out of weir 106. Higher speeds create more stress on screen drum 101, and variable speed module 600 allows a balance of throughput, stress, and settling of solids. The control loop is be continuous, progressive, and/or a step function in various alternatives.

Numerous modifications may be made to the present disclosure which still fall within the intended scope hereof Thus, it should be apparent that there has been provided a method and apparatus for filtering water that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims

1. A food processing water filtration apparatus, comprising;
a rotatable drum having a first end and a second end, and having a cylindrical surface at least partially comprised of a screen;
a source of liquid with suspended solids to be filtered disposed outside the drum and capable of directing at least a portion of the liquid towards the screen and into the drum;
a blade disposed to remove solids from the exterior of the drum;
a drain located below the drum to collect at least a second portion of the liquid that passes through the screen and out of the drum;
a solids outlet located at one of the first end of the drum and the second end of the drum;
a rotational drive connected to at least one of the first and second ends of the drum, whereby the rotational drive can cause the drum to rotate; and
a plurality of flights affixed to the interior of the drum.

2. The apparatus of claim 1, further comprising a source of mixing gas connected to the source of liquid with suspended solids.

3. The apparatus of claim 2, further comprising:
a source of cleaning fluid; and
a plurality of nozzles connected to the source of cleaning fluid and disposed inside the drum to direct the cleaning fluid to the screen to clean the screen.

4. The apparatus of claim 3, wherein the source of cleaning fluid includes a source of cleaning gas, and wherein the source of cleaning gas is connected to the plurality of nozzles.

5. The apparatus of claim 2, further comprising a first trunnion support disposed at the first end of the drum to support the first end of the drum.

6. The apparatus of claim 5, further comprising:
a source of cleaning fluid; and
a plurality of nozzles connected to the source of cleaning fluid and disposed inside the drum to direct the cleaning fluid to the screen to clean the screen.

7. The apparatus of claim 6, wherein the source of cleaning fluid includes a source of cleaning gas, and wherein the source of cleaning gas is connected to the plurality of nozzles.

8. The apparatus of claim 1, further comprising:
a source of cleaning fluid; and
a plurality of nozzles connected to the source of cleaning fluid and disposed inside the drum to direct the cleaning fluid to the screen to clean the screen.

9. The apparatus of claim 8, wherein the source of cleaning fluid includes a source of cleaning gas, and wherein the source of cleaning gas is connected to the plurality of nozzles.

10. The apparatus of claim 1, further comprising a first trunnion support disposed at the first end of the drum to support the first end of the drum.

11. The apparatus of claim 10, further comprising:
a source of cleaning fluid; and
a plurality of nozzles connected to the source of cleaning fluid and disposed inside the drum to direct the cleaning fluid to the screen to clean the screen.

12. The apparatus of claim 11, wherein the source of cleaning fluid includes a source of cleaning gas, and wherein the source of cleaning gas is connected to the plurality of nozzles.

13. The apparatus of claim 1, wherein the flights are rigid and thereby provide rigidity to the drum, and further wherein as the drum rotates the flights move filtered material toward the first end.

14. The apparatus of claim 1, further comprising a variable speed module connected to the source of liquid with suspended solids to be filtered, and connected to control the rotational drive, and disposed to sense a level of fluid in the source of liquid with suspended solids to be filtered, and further connected to control a speed of the rotational drive in response thereto.

15. A food processing water filtration apparatus, comprising;
a rotatable drum having a first end and a second end, and having a cylindrical surface at least partially comprised of a screen;
a source of liquid with suspended solids to be filtered disposed outside the drum and capable of directing at least a portion of the liquid towards the screen and into the drum;
a blade disposed to remove solids from the exterior of the drum;
a drain located below the drum to collect at least a second portion of the liquid that passes through the screen and out of the drum;
a solids outlet located at one of the first end of the drum and the second end of the drum;
a rotational drive connected to at least one of the first and second ends of the drum, whereby the rotational drive can cause the drum to rotate; and
a source of mixing gas connected to the source of liquid with suspended solids.

16. The apparatus of claim 15, further comprising a first trunnion support disposed at the first end of the drum to support the first end of the drum.

17. The apparatus of claim 16, further comprising:
a source of cleaning fluid; and
a plurality of nozzles connected to the source of cleaning fluid and disposed inside the drum to direct the cleaning fluid to the screen to clean the screen.

18. The apparatus of claim 17, wherein the source of cleaning fluid includes a source of cleaning gas, and wherein the source of cleaning gas is connected to the plurality of nozzles.

19. The apparatus of claim 18, further comprising:
a source of cleaning fluid; and
a plurality of nozzles connected to the source of cleaning fluid and disposed inside the drum to direct the cleaning fluid to the screen to clean the screen.

20. The apparatus of claim 19, wherein the source of cleaning fluid includes a source of cleaning gas, and wherein the source of cleaning gas is connected to the plurality of nozzles.

21. The apparatus of claim 15, further comprising a variable speed module connected to the source of liquid with suspended solids to be filtered, and connected to control the rotational drive, and disposed to sense a level of fluid in the source of liquid with suspended solids to be filtered, and further connected to control a speed of the rotational drive in response thereto.

22. A food processing water filtration apparatus, comprising;
a rotatable drum having a first end and a second end, and having a cylindrical surface at least partially comprised of a screen;
a source of liquid with suspended solids to be filtered disposed outside the drum and capable of directing at least a portion of the liquid towards the screen and into the drum;
a blade disposed to remove solids from the exterior of the drum;
a drain located below the drum to collect at least a second portion of the liquid that passes through the screen and out of the drum;
a solids outlet located at one of the first end of the drum and the second end of the drum;
a rotational drive connected to at least one of the first and second ends of the drum, whereby the rotational drive can cause the drum to rotate;
a source of cleaning gas; and
a plurality of nozzles connected to the source of cleaning gas and disposed inside the drum to direct the cleaning fluid to the screen to clean the screen.

23. The apparatus of claim 22, further comprising a source of cleaning liquid, and wherein the source of cleaning liquid is connected to the plurality of nozzles.

24. The apparatus of claim 22, further comprising a first trunnion support disposed at the first end of the drum to support the first end of the drum.

25. The apparatus of claim 24, further comprising a source of cleaning liquid, and wherein the source of cleaning liquid is connected to the plurality of nozzles.

26. The apparatus of claim 22, further comprising a variable speed module connected to the source of liquid with suspended solids to be filtered, and connected to control the rotational drive, and disposed to sense a level of fluid in the source of liquid with suspended solids to be filtered, and further connected to control a speed of the rotational drive in response thereto.

27. A food processing water filtration apparatus, comprising;
a rotatable drum having a first end and a second end, and having a cylindrical surface at least partially comprised of a screen;
a source of liquid with suspended solids to be filtered disposed outside the drum and capable of directing at least a portion of the liquid towards the screen and into the drum;
a blade disposed to remove solids from the exterior of the drum;
a drain located below the drum to collect at least a second portion of the liquid that passes through the screen and out of the drum;
a solids outlet located at one of the first end of the drum and the second end of the drum;
a rotational drive connected to at least one of the first and second ends of the drum, whereby the rotational drive can cause the drum to rotate; and
a first trunnion support disposed at the first end of the drum to support the first end of the drum.

28. The apparatus of claim 27, further comprising a variable speed module connected to the source of liquid with suspended solids to be filtered, and connected to control the rotational drive, and disposed to sense a level of fluid in the source of liquid with suspended solids to be filtered, and further connected to control a speed of the rotational drive in response thereto.

29. The apparatus of claim 28, further comprising a second trunnion support disposed at a second end of the drum to support the second end of the drum.

30. The apparatus of claim 29, further comprising a variable speed module connected to the source of liquid with suspended solids to be filtered, and connected to control the rotational drive, and disposed to sense a level of fluid in the source of liquid with suspended solids to be filtered, and further connected to control a speed of the rotational drive in response thereto.
